(19) United States
(12) Patent Application Publication
(10) Pub. No.: US 2026/0094526 A1
(43) Pub. Date: Apr. 2, 2026

(54) INFORMATION PROVIDING APPARATUS, INFORMATION PROVIDING METHOD, AND NON-TRANSITORY STORAGE MEDIUM

(71) Applicant: NEC Corporation, Tokyo (JP)

(72) Inventors: Takashi NONAKA, Tokyo (JP); Taiga TAKAHASHI, Tokyo (JP); Mamoru HIROTA, Tokyo (JP); Kentaro NISHIDA, Tokyo (JP)

(73) Assignee: NEC Corporation, Tokyo (JP)

(21) Appl. No.: 19/332,191

(22) Filed: Sep. 18, 2025

(30) Foreign Application Priority Data
Sep. 27, 2024 (JP) 2024-168961

(51) Int. Cl. G09B 5/02

(52) U.S. Cl. CPC G09B 5/02

(57) ABSTRACT

An information providing device provides a target space for performing training regarding maintenance of a maintenance target to a training subject, the target space being a virtual space or cross-reality, and includes an acquisition unit, a training data acquisition unit, and a providing unit. The acquisition unit acquires environment information. The environment information includes at least one of area information that can specify an area which the subject is in charge of and climate information on climate in the area. The training data acquisition unit acquires training data that is data related to the maintenance target and is to be reflected in the target space using the environment information. The providing unit executes processing for providing the target space reflecting the training data to the communication device used by the subject.

This application is based upon and claims the benefit of priority from Japanese patent application No. 2024-168961, filed on September 27, 2024, the disclosure of which is incorporated herein in its entirety by reference.

### TECHNICAL FIELD

The present invention relates to an information providing device, an information providing method, and a program.

### BACKGROUND ART

In recent years, workers are often required to have various skills. For this reason, the worker may receive training for the purpose of acquiring necessary skills. For example, JP 2023-11488 A discloses a system for performing this training using an image. More specifically, the system displays a first image related to a vocational training, and accepts an operation from a trainee taking the vocational training. The system acquires first biological information including at least the amount of perspiration of the trainee who views the first image. Then, the system calculates a first value related to stress of the trainee from the first biological information, and estimates characteristics of the trainee regarding work associated with the vocational training based on the first value.

### SUMMARY

One of the tasks performed by a maintenance worker is maintenance of a maintenance target. On the other hand, the content of maintenance of the device may vary depending on an area where the device is used and a climate while maintenance is performed. Therefore, at least one of the area and the climate may be reflected in the content of the training performed by the subject.

An information providing device according to one aspect of the present disclosure is a device for providing a target space for performing training regarding maintenance of a maintenance target, the target space being a virtual space or cross-reality, to a subject of the training, including acquisition means for acquiring environment information including at least one of area information capable of specifying an area which the subject is in charge of and climate information related to a climate in the area, training data acquisition means for acquiring training data that is data regarding the maintenance target and is to be reflected in the target space by using the environment information, and providing means for executing processing for providing the target space reflecting the training data to a communication device used by the subject.

An information providing method according to one aspect of the present disclosure causes a computer for providing a target space for performing training regarding maintenance of a maintenance target, the target space being a virtual space or cross-reality, to a subject of the training, to execute acquiring environment information including at least one of area information capable of specifying an area which the subject is in charge of and climate information related to a climate in the area, acquiring training data that is data regarding the maintenance target and is to be reflected in the target space by using the environment information, and executing processing for providing the target space reflecting the training data to a communication device used by the subject.

A program according to one aspect of the present disclosure causes a computer for providing a target space for performing training regarding maintenance of a maintenance target, the target space being a virtual space or cross-reality, to a subject of the training, to include acquisition means for acquiring environment information including at least one of area information capable of specifying an area which the subject is in charge of and climate information related to a climate in the area, training data acquisition means for acquiring training data that is data regarding the maintenance target and is to be reflected in the target space by using the environment information, and providing means for executing processing for providing the target space reflecting the training data to a communication device used by the subject.

According to an example of the present disclosure, at least one of the area and the climate can be reflected in the content of the training performed by the subject.

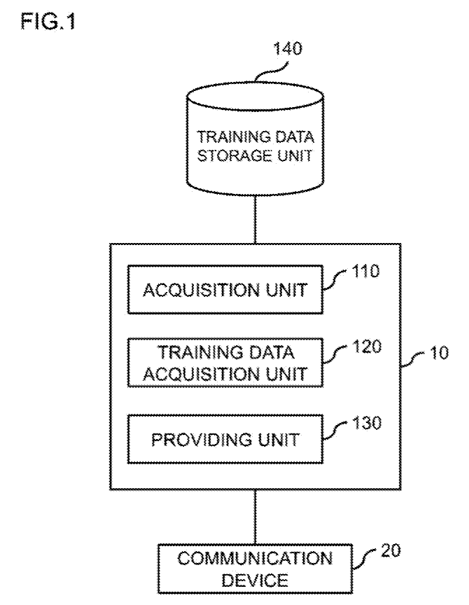

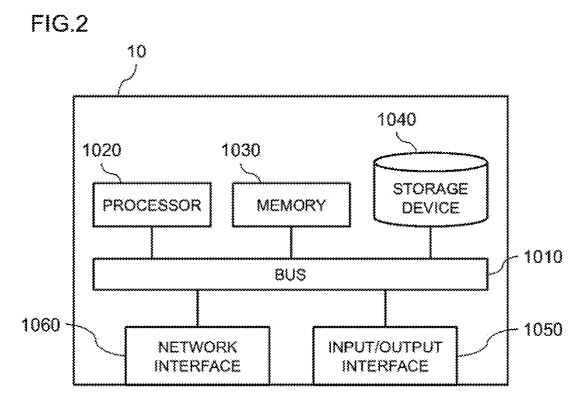

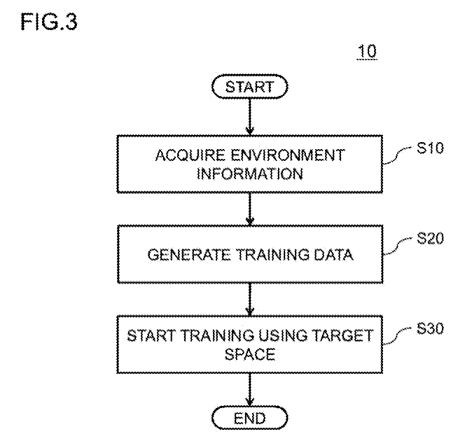

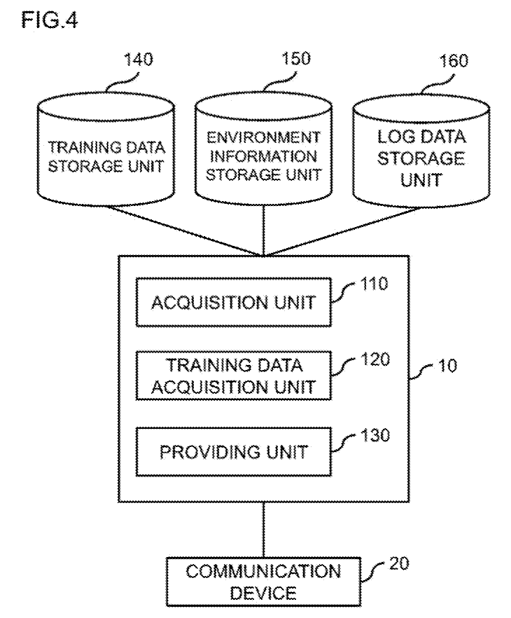

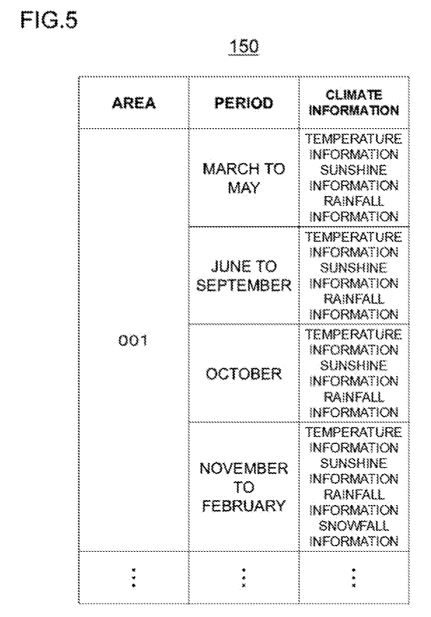

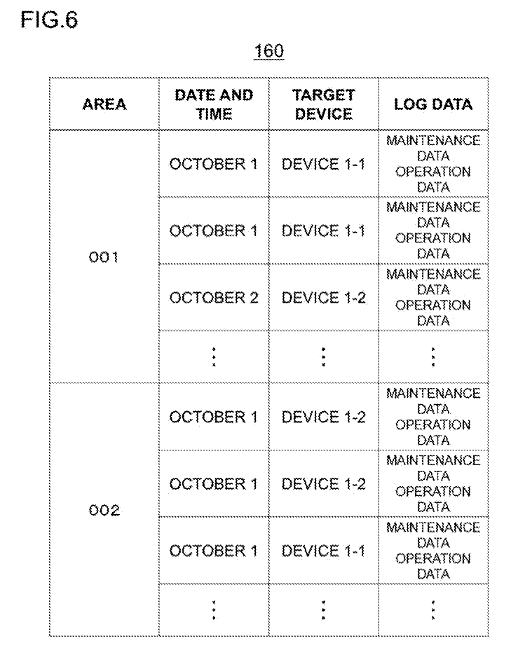

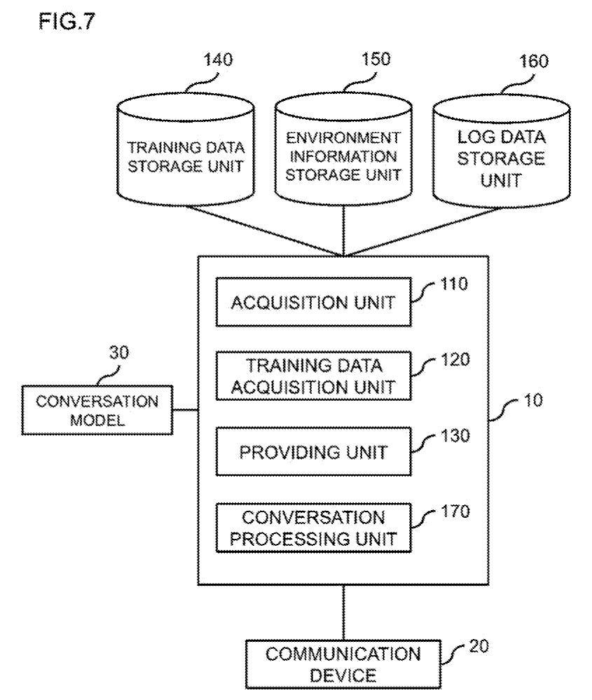

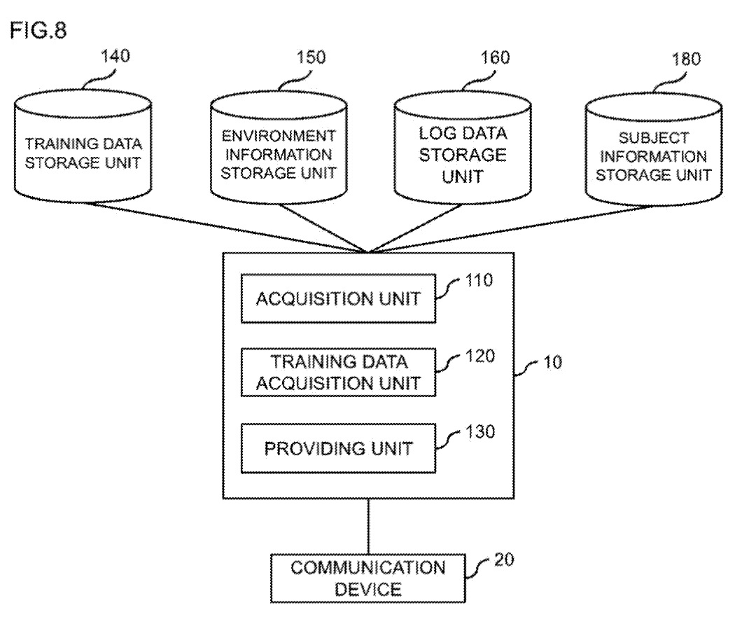

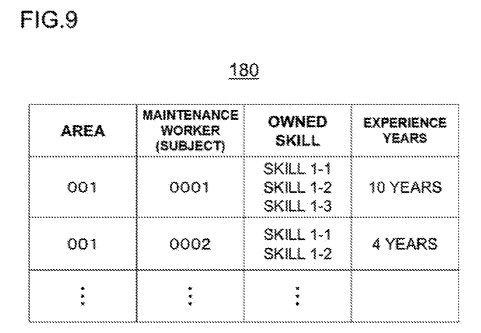

### BRIEF DESCRIPTION OF THE DRAWINGS

[FIG. 1] It is a diagram illustrating an example of a functional configuration of an information providing device according to the present disclosure together with a usage environment of the information providing device;

[FIG. 2] It is a diagram illustrating a hardware configuration example of the information providing device;

[FIG. 3] It is a flowchart illustrating an example of processing performed by the information providing device;

[FIG. 4] It is a diagram illustrating an example of a functional configuration of the information providing device together with a usage environment of the information providing device;

[FIG. 5] It is a diagram illustrating an example of information stored in an environment information storage unit;

[FIG. 6] It is a diagram illustrating an example of information stored in a log data storage unit;

[FIG. 7] It is a diagram illustrating an example of the functional configuration of the information providing device together with the usage environment of the information providing device;

[FIG. 8] It is a diagram illustrating an example of the functional configuration of the information providing device together with a use environment of the information providing device; and

[FIG. 9] It is a diagram illustrating an example of information stored in a subject information storage unit.

### EXAMPLE EMBODIMENT

Hereinafter, in the present disclosure, the drawings are associated with one or more example embodiments. In all the drawings, similar components are denoted by similar reference signs, and descriptions thereof will be omitted as appropriate.

An information providing device 10 is used in a case where a maintenance worker who performs maintenance on a maintenance target performs training regarding the maintenance. This training is performed in a virtual space or cross-reality. Hereinafter, the virtual space or a space based on the cross-reality will be referred to as a target space.

The maintenance target is, for example, at least one of the following.

Electric device. An example of the electric device is at least one of an air conditioner having a temperature control function, a refrigerator, a washing machine, an information processing device such as a personal computer, and a printer.

Automobile. An automobile includes at least one of a vehicle driven by an internal combustion engine, an electric vehicle, a hybrid vehicle, and a fuel cell vehicle.

Gas appliance. An example of a gas appliance is at least one of a water heater and a gas stove.

Water supply equipment used in buildings. For example, the water supply equipment is at least one of a water supply distribution system and a sewerage drainage system.

The information providing device 10 is used together with a communication device 20 for the maintenance worker to experience the target space. The communication device 20 may be, for example, a device worn on a body of a maintenance worker, such as smart glasses, or may be other devices, for example, a stationary communication device such as a personal computer, or a portable communication device such as a tablet communication device or a smartphone. In any example, the communication device 20 includes a display, a microphone, and a speaker, or is connected to the display, the microphone, and the speaker.

A maintenance worker is often responsible for multiple types of devices. Even for the same type of maintenance target, a maintenance content... may vary depending on at least one of an area where the maintenance target is used and a climate at the timing of performing maintenance. Therefore, the information providing device 10 adjusts data which is used in the target space and relates to the maintenance target using at least one of the area and the climate.

The area may be set, for example, on a national basis, on a local basis in one country, or on a municipal basis.

The climate may be set, for example, by using a season, may be set by using a month, or may be set by using a numerical range for at least one of temperature, humidity, sunshine hours, a rainfall amount, and a snow accumulation amount.

The skills that can be acquired by the maintenance worker by training include, for example, at least one of the following.

There is an ability to maintain a maintenance target. The skills are set, for example, for each maintenance target. In a case where a plurality of types of maintenance contents is assumed, for example, in a case where there is a plurality of at least one of a cause of a failure and a coping method, the skill may be set for each of the plurality of types.

The information providing device 10 can use, for example, a training data storage unit 140. The training data storage unit 140 may be a part of the information providing device 10 or may be located outside the information providing device 10.

The training data storage unit 140 stores various types of data necessary for the information providing device 10 to provide the training data. The data stored in the training data storage unit 140 includes, for example, the following.

(1) Data for generating a target space.

(2) Data related to a maintenance target and to be reflected in a target space. Hereinafter, this data is referred to as training data.

The training data includes, for example, data for operating the maintenance target in the target space according to an input performed by the maintenance worker via the communication device 20. The training data is stored, for example, for each area, and reflects predetermined maintenance contents, for example, a method of specifying a cause of a failure and a method of coping with the cause.

The training data may further be stored for each period as at least part of climate information. The period used here is, for example, a season or a month, but is not limited thereto. In the training data storage unit 140, at least one of temperature, humidity, a sunshine time, a rainfall amount, and a snow accumulation amount may be used as the climate information instead of the period. These are indicated by, for example, average values in a predetermined period. The predetermined period is, for example, a season or a month, but is not limited thereto.

In a case where there may be a plurality of maintenance contents, the training data may be further stored in the training data storage unit 140 for each maintenance factor. In a case where there is a plurality of types of maintenance targets, the training data may be further stored in the training data storage unit 140 for each maintenance target.

Then, the information providing device 10 is a device for providing a target space for performing training related to maintenance of a maintenance target to a maintenance worker who is a training subject, and includes an acquisition unit 110, a training data acquisition unit 120, and a providing unit 130.

The acquisition unit 110 acquires environment information. The environment information includes at least one of area information capable of specifying an area in charge of the training subject and climate information on climate in the area. The environment information may be only area information, only environment information, or both the area information and the environment information. At least a part of the environment information may be information indicating a period. These pieces of information are input by the subject via the communication device 20, for example.

The training data acquisition unit 120 acquires training data using the environment information acquired by the acquisition unit 110. For example, the training data acquisition unit 120 acquires training data associated with the environment information. As an example, the training data acquisition unit 120 reads the training data associated with the environment information from the training data storage unit 140.

The providing unit 130 executes processing for providing the target space reflecting the training data to the communication device 20. For example, the providing unit 130 generates data for generating the target space using the data read from the training data storage unit 140, and transmits the data to the communication device 20.

The communication device 20 causes a display to display the target space. This display includes, for example, a maintenance target. Then, the communication device 20 transmits, to the providing unit 130, the input performed on the communication device 20 by the subject who looks at the display. An example of this input includes information indicating what kind of inspection should be performed on the maintenance target in the target space. This information includes removing a part such as a cover to be maintained, replacing a part, performing measurement on a part, and replacing at least one of parts for achieving a function to be maintained. The measurements here include, for example, electric measurements and include measurements necessary to specify a maintenance factor, for example, the cause of the failure.

Then, the providing unit 130 performs processing according to the input performed on the communication device 20. An example of this processing includes at least one of displaying a maintenance target in a state where a part is removed, displaying a measurement result, displaying a coping method based on the measurement result, for example, displaying information indicating a part to be replaced, displaying information indicating whether maintenance content of the maintenance target has been eliminated by replacing the part, for example, displaying information indicating whether a failure has been cured.

As illustrated in FIG. 2, for example, the information providing device 10 includes a bus 1010, a processor 1020, a memory 1030, a storage device 1040, an input/output interface 1050, and a network interface 1060 as a hardware configuration.

The bus 1010 is a data transmission path for the processor 1020, the memory 1030, the storage device 1040, the input/output interface 1050, and the network interface 1060 to transmit and receive data to and from each other. However, the method for connecting the processor 1020 and the like to each other is not limited to the bus connection.

The processor 1020 is a processor implemented by a central processing unit (CPU), a graphics processing unit (GPU), or the like.

The memory 1030 is a main storage device implemented by a random access memory (RAM) or the like.

The storage device 1040 is an auxiliary storage device implemented by a removable medium such as a hard disk drive (HDD), a solid state drive (SSD), and a memory card, or a read only memory (ROM), and has a recording medium. A recording medium of the storage device 1040 stores a program module that achieves each function (for example, the acquisition unit 110, the training data acquisition unit 120, the providing unit 130, and a conversation processing unit 170 to be described later) of the information providing device 10. The processor 1020 implements the functions associated to the program modules by reading and executing the program modules on the memory 1030. The storage device 1040 may further function as at least one of the training data storage unit 140, and an environment information storage unit 150, a log data storage unit 160, and a subject information storage unit 180 to be described later.

The input/output interface 1050 is an interface for connecting the information providing device 10 and various input/output devices. For example, the information providing device 10 may communicate with at least one of the training data storage unit 140, the environment information storage unit 150, the log data storage unit 160, and the subject information storage unit 180 via the input/output interface 1050.

The network interface 1060 is an interface for connecting the information providing device 10 to a network. The network is, for example, a local area network (LAN) or a wide area network (WAN). A method for connecting the network interface 1060 to the network may be a wireless connection or a wired connection. The information providing device 10 may communicate with at least one of the communication device 20, the training data storage unit 140, the environment information storage unit 150, the log data storage unit 160, and the subject information storage unit 180 via the network interface 1060.

The information providing device 10 operates as illustrated in FIG. 3, for example. First, the subject to be trained inputs environment information, that is, at least one of the area information and the climate information, to the communication device 20. Then, the communication device 20 transmits the environment information to the information providing device 10.

The acquisition unit 110 of the information providing device 10 acquires the environment information (step S10). Next, the training data acquisition unit 120 of the information providing device 10 acquires training data associated with the environment information (step S120). Next, the providing unit 130 starts processing for causing the subject to perform training using the target space by using the training data (step S30). An example of this processing is as described with reference to FIG. 1.

As described above, in a case where the information providing device 10 is used, at least one of the area and the climate is reflected in the training data. Therefore, the subject can efficiently perform training.

As illustrated in FIG. 4, the information providing device 10 may further include an environment information storage unit 150 and a log data storage unit 160.

The environment information storage unit 150 stores climate information for each area and each period as illustrated in FIG. 5, for example. The period may be, for example, on a seasonal basis, on a monthly basis, or on a weekly basis. The climate information indicates at least one of temperature, humidity, sunshine hours, a rainfall amount, and a snow accumulation amount. The climate information is, for example, an average value, but may be a history in a predetermined period, for example, a history in a day.

For example, as illustrated in FIG. 6, the log data storage unit 160 stores log data for each area. The log data storage unit 160 stores the log data for each maintenance target whose maintenance has been further performed. In a case where the maintenance target is a device, the log data includes, for example, at least one of the following.

### (1) Operation data

The operation data includes, for example, at least one of the following: The operation data may be a history of these.

Operating mode of device

At least one of information regarding control data used inside the device, a temperature of at least one of a periphery and an inside of the device, and a current inside the maintenance target.

At least one of a refrigerant pressure and a set temperature in a case where the device is an air conditioning device having a temperature control function

### (2) Maintenance data and date of maintenance

The maintenance data is maintenance data related to a factor of maintenance, for example, data indicating a symptom occurring in the maintenance target, and may include text data describing the symptom or may include failure identification information indicating a type of failure occurring in the device. In a case where the device to be maintained is a device having a display, an example of the failure identification information is an error code displayed on the display.

Then, the training data acquisition unit 120 of the information providing device 10 generates training data using, for example, the environment information storage unit 150 and the log data storage unit 160. The generated training data may be stored in the training data storage unit 140, may be used as it is, or may be stored in the training data storage unit 140 and used.

For example, the training data acquisition unit 120 acquires, from the log data storage unit 160, log data during operation of the device that has been operating under a condition associated with the environment information acquired by the acquisition unit 110. Hereinafter, this log data is referred to as associated log data. Then, the training data acquisition unit 120 generates training data using the acquired associated log data.

For example, in a case where the environment information acquired by the acquisition unit 110 includes an area and a period, the training data acquisition unit 120 acquires log data associated with a combination of the area and the period as the associated log data. Then, the training data acquisition unit 120 performs statistical processing on the operation data included in the associated log data for each failure type, and includes a result of the statistical processing in the training data associated with the failure type. The period used here is, for example, a season or a month.

In a case where the environment information acquired by the acquisition unit 110 includes a numerical range of at least one of the temperature, the humidity, the sunshine time, the rainfall amount, and the snow accumulation amount, the training data acquisition unit 120 specifies a combination of an area satisfying this numerical range and one of the season and the month using the information stored in the environment information storage unit 150. Then, the training data acquisition unit 120 acquires log data associated with this combination as associated log data. Then, the training data acquisition unit 120 performs statistical processing on the operation data included in the associated log data for each failure type, and includes a result of the statistical processing in the training data associated with the failure type.

In a case where the environment information acquired by the acquisition unit 110 includes an average value of at least one of the temperature, the humidity, the sunshine time, the rainfall amount, and the snow accumulation amount acquired by the acquisition unit 110, the training data acquisition unit 120 may set a numerical range including the average value and perform the above-described processing.

In a case where there is a plurality of types of failures, the training data acquisition unit 120 may select data related to the cause of the failure in which at least one of an occurrence frequency and an occurrence probability satisfies a criterion under a condition associated with designated environment information, and include only the selected log data in the associated log data. In this way, the training data acquisition unit 120 generates only the training data associated with the cause of the failure occurring at a certain frequency or probability in the environment information for each environment information. Therefore, the subject can efficiently perform training.

The occurrence frequency is indicated by, for example, the number of occurrences per predetermined period. The occurrence probability is indicated by, for example, a rate of failures to the total number of maintenances per predetermined period. The predetermined period here is set in a range of, for example, one week or more and three months or less, but is not limited thereto.

In a case where the log data associated with a combination of the area information and the period cannot be obtained, for example, in a case where the log data associated with the combination is not stored in the log data storage unit 160, the training data acquisition unit 120 may specify another combination of the area and the period information satisfying an alternative criterion related to the climate and acquire the log data associated with the combination as associated log data.

For example, the training data acquisition unit 120 acquires climate data of a period during which a training is performed from, for example, the environment information storage unit 150. Then, the training data acquisition unit 120 specifies a combination of an area and a period having climate data similar to the climate data using the data stored in the environment information storage unit 150. Then, the training data acquisition unit 120 acquires the log data associated with the specified combination from the log data storage unit 160 as the associated log data.

Here, an example of a criterion for determining “similar weather data”, that is, an alternative criterion is that numerical ranges for at least one of temperature, humidity, a sunshine time, a rainfall amount, and a snow accumulation amount overlap each other by a certain percentage or more. The certain percentage here is, for example, 50%, but may be more, for example, 60%, 70%, or 80%, or may be less, for example, 40% or 30%.

The training data acquisition unit 120 may generate the above-described training data even at a timing at which the acquisition unit 110 does not acquire the environment information. In this case, the training data acquisition unit 120 may periodically perform the above-described training data generation processing on all the combinations of the area and one of the season and the month.

The information providing device 10 may include a conversation processing unit 170, for example, as illustrated in FIG. 7. The conversation processing unit 170 performs processing for dialoguing with the subject as the owner or an administrator of the maintenance target. Hereinafter, the owner or the administrator is referred to as “owner”. The conversation processing unit 170 performs this processing using a conversation model 30. The conversation model 30 is a so-called conversation artificial intelligence (AI), and is generated by being trained on conversations actually performed between the owner and the maintenance worker. The conversation model 30 may be a part of the information providing device 10 or may be provided in a device outside the information providing device 10.

For example, the subject inputs, to the communication device 20, a text or a voice as an inquiry or a description to the owner of the maintenance target. Then, the communication device 20 transmits input information to the information providing device 10. The conversation processing unit 170 inputs this information to the conversation model 30. The conversation model 30 generates response information associated with this input, and outputs the response information to the conversation processing unit 170. Then, the conversation processing unit 170 transmits the response information to the communication device 20. The communication device 20 outputs the response information to cause the subject to recognize the response information. This output may be displaying text on a display, outputting voice, or both.

The above processing may be repeatedly performed in parallel with the processing performed by the providing unit 130.

In a case where the information providing device 10 includes the conversation processing unit 170, the subject can also experience a conversation with the owner in a pseudo manner. Therefore, quality of the training performed on the subject is improved.

As illustrated in FIG. 8, the information providing device 10 may be able to use the subject information storage unit 180. The subject information storage unit 180 stores various types of information regarding the subject. The subject information storage unit 180 may be a part of the information providing device 10 or may be located outside the information providing device 10.

Then, the acquisition unit 110 further acquires subject information. Then, the training data acquisition unit 120 further generates training data using the subject information acquired by the acquisition unit 110.

For example, as illustrated in FIG. 9, the subject information includes at least one of information (for example, area identification information) that can specify an area which the subject is in charge of, information (for example, skill identification information) that can specify a skill possessed by the subject, and the number of years since the subject became a maintenance worker.

Then, in a case where the training data acquisition unit 120 acquires information capable of specifying an area in charge of the subject, the training data acquisition unit 120 acquires training data associated with the area.

In a case where the training data acquisition unit 120 acquires information that can specify a skill possessed by the subject, the training data acquisition unit 120 specifies a maintenance content requiring a skill other than the skill and acquires training data associated with the maintenance content. For example, the subject information storage unit 180 stores, for each of a plurality of maintenance contents, information that can specify a skill necessary for the maintenance content. Then, the training data acquisition unit 120 specifies the maintenance content to be trained using this information.

In this way, at least one of the area and the climate can be reflected in the content of the training performed by the subject. Therefore, the information providing device 10 can provide the subject with a training content suitable for the subject. Therefore, quality of the training performed on the subject is improved.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

While a plurality of steps (processes) is described in order in the plurality of flowcharts used in the descriptions above, the execution order of the steps executed in each example embodiment is not limited to the described order. In each example embodiment, the order of the illustrated steps can be changed as long as nothing interferes in terms of content.

Some or all of the example embodiments described above may be described as the following Supplementary Notes, but are not limited to the following.

1. An information providing device for providing a target space for performing training regarding maintenance of a maintenance target, the target space being a virtual space or cross-reality, to a subject of the training, the information providing device including:

acquisition means for acquiring environment information including at least one of area information capable of specifying an area which the subject is in charge of and climate information related to a climate in the area; training data acquisition means for acquiring training data that is data regarding the maintenance target and is to be reflected in the target space by using the environment information; and providing means for executing processing for providing the target space reflecting the training data to a communication device used by the subject.

2. The information providing device according to Supplementary Note 1, in which the training data acquisition means acquires associated log data that is log data during operation of the maintenance target operating under a condition associated with the environment information, and generates the training data using the associated log data.

3. The information providing device according to Supplementary Note 2, in which the associated log data includes maintenance data related to a factor of the maintenance.

4. The information providing device according to Supplementary Note 3, in which the maintenance content includes a cause of failure, there are a plurality of types of causes of the failure, and the training data acquisition means selects the log data related to the cause of the failure in which at least one of an occurrence frequency and an occurrence probability satisfies a criterion under a condition associated with the environment information, and includes only the selected log data in the associated log data.

5. The information providing device according to any one of Supplementary Notes 2 to 4, in which the maintenance target is a device, and the associated log data includes at least one of information related to an operation mode of the maintenance target, failure identification information indicating a type of a failure occurring in the maintenance target, control data used inside the maintenance target, a temperature of at least one of a periphery and an inside of the maintenance target, and a current inside the maintenance target.

6. The information providing device according to any one of Supplementary Notes 2 to 4, in which the environment information includes the area information and a period as at least a part of the climate information.

7. The information providing device according to Supplementary Note 6, in which in a case where the log data associated with a combination of the area information and the period cannot be obtained, the training data acquisition means specifies another combination of the area and the period satisfying an alternative criterion related to climate, and acquires the log data associated with the combination as the associated log data.

8. The information providing device according to any one of Supplementary Notes 1 to 7, further including conversation processing means for performing processing for having a conversation with the subject as an owner or an administrator of the maintenance target.

9. The information providing device according to any one of Supplementary Notes 1 to 8, in which the acquisition means further acquires subject information regarding the subject, and the training data acquisition means further generates the training data using the subject information.

10. An information providing method causing a computer for providing a target space for performing training regarding maintenance of a maintenance target, the target space being a virtual space or cross-reality, to a subject of the training, to execute: acquiring environment information including at least one of area information capable of specifying an area which the subject is in charge of and climate information related to a climate in the area; acquiring training data that is data regarding the maintenance target and is to be reflected in the target space by using the environment information; and executing processing for providing the target space reflecting the training data to a communication device used by the subject.

11. A program causing a computer for providing a target space for performing training regarding maintenance of a maintenance target, the target space being a virtual space or cross-reality, to a subject of the training, to include: acquisition means for acquiring environment information including at least one of area information capable of specifying an area which the subject is in charge of and climate information related to a climate in the area; training data acquisition means for acquiring training data that is data regarding the maintenance target and is to be reflected in the target space by using the environment information; and providing means for executing processing for providing the target space reflecting the training data to a communication device used by the subject.

12. A recording medium in which the program according to Supplementary Note 11 is recorded.

Some or all of the configurations described in Supplementary Notes 2 to 9 dependent on the above-described Supplementary Note 1 can also be dependent on each of Supplementary Notes 10 to 12 by the same dependency relationship as in Supplementary Notes 2 to 9. Not only Supplementary Notes 1 and 10 to 12, but also various hardware, software, various recording means for recording software, or systems can be similarly dependent on some or all of the configurations described as the supplementary notes without departing from the above-described example embodiments.

1. An information providing apparatus for providing a target space for performing training regarding maintenance of a maintenance target, the target space being a virtual space or cross-reality, to a subject of the training, the information providing device comprising:
acquisition means for acquiring environment information comprising at least one of area information capable of specifying an area which the subject is in charge of and climate information related to a climate in the area;
training data acquisition means for acquiring training data that is data regarding the maintenance target and is to be reflected in the target space by using the environment information; and
providing means for executing processing for providing the target space reflecting the training data to a communication device used by the subject.

2. The information providing apparatus according to claim 1, wherein
the training data acquisition means acquires associated log data that is log data during operation of the maintenance target operating under a condition associated with the environment information, and generates the training data using the associated log data.

3. The information providing apparatus according to claim 2, wherein
the associated log data comprises maintenance data related to a factor of the maintenance.

4. The information providing apparatus according to claim 3, wherein
the maintenance content comprises a cause of failure,
there are a plurality of types of causes of the failure, and
the training data acquisition means selects the log data related to the cause of the failure in which at least one of an occurrence frequency and an occurrence probability satisfies a criterion under a condition associated with the environment information, and comprises only the selected log data in the associated log data.

5. The information providing apparatus according to claim 2, wherein
the maintenance target is a device, and
the associated log data comprises at least one of information related to an operation mode of the maintenance target, failure identification information indicating a type of a failure occurring in the maintenance target, control data used inside the maintenance target, a temperature of at least one of a periphery and an inside of the maintenance target, and a current inside the maintenance target.

6. The information providing apparatus according to claim 2, wherein
the environment information comprises the area information and a period as at least a part of the climate information.

7. The information providing apparatus according to claim 6, wherein
in a case where the log data associated with a combination of the area information and the period cannot be obtained, the training data acquisition means specifies another combination of the area and the period satisfying an alternative criterion related to climate, and acquires the log data associated with the combination as the associated log data.

8. The information providing apparatus according to claim 1, further comprising
conversation processing means for performing processing for having a conversation with the subject as an owner or an administrator of the maintenance target.

9. An information providing method causing a computer for providing a target space for performing training regarding maintenance of a maintenance target, the target space being a virtual space or cross-reality, to a subject of the training, to execute:
acquiring environment information comprising at least one of area information capable of specifying an area which the subject is in charge of and climate information related to a climate in the area;
acquiring training data that is data regarding the maintenance target and is to be reflected in the target space by using the environment information; and
executing processing for providing the target space reflecting the training data to a communication device used by the subject.

10. A non-transitory storage medium storing a program causing a computer for providing a target space for performing training regarding maintenance of a maintenance target, the target space being a virtual space or cross-reality, to a subject of the training, to comprise:
acquiring environment information comprising at least one of area information capable of specifying an area which the subject is in charge of and climate information related to a climate in the area;
acquiring training data that is data regarding the maintenance target and is to be reflected in the target space by using the environment information; and
providing the target space reflecting the training data to a communication device used by the subject.
